(19) United States
(12) Patent Application Publication
(10) Pub. No.: US 2008/0313807 A1
(43) Pub. Date: Dec. 25, 2008

(54) Transferring device for bed

(76) Inventor: Yu-Wen Cheng, Taichung City (TW)

Correspondence Address: PRO-TECHTOR INTERNATIONAL SERVICES, 20775 NORADA CT., SARATOGA, CA, 95070, US

(21) Appl. No.: 11/821,184

(22) Filed: Jun. 22, 2007

(51) Int. Cl. A61G 7/10

(52) U.S. Cl. 5/83.1

(57) ABSTRACT

A transferring device for a bed, placed on a bed plate, on top of or below a mattress, comprises a first inflatable bag; placed on the bed plate and having in an inflated state a triangular shape, with a inner and outer edges having different heights; a second inflatable bag; placed on the first inflatable bag and having in an inflated state a triangular shape, with a inner and outer edges having different heights; and a compressor for inflating and deflating the first and second inflatable bags.

### FIELD OF THE INVENTION

The present invention relates to a transferring device for a bed, particularly to a transferring device for a bed for facilitating moving of a patient into and out of a bed.

### BACKGROUND OF THE INVENTION

Moving a severely sick or disabled patient into or out of a bed is a difficult and bothersome task. Conventionally, this task is alleviated by using a mattress with a smooth lower surface to minimize friction. Even then, a lot of physical effort is required. If the bed is not movable or placed next to a wall, moving the patient is even harder.

### SUMMARY OF THE INVENTION

It is the object of the present invention to provide a transferring device for a bed for moving a patient into and out of the bed with minimal physical effort.

For achieving above object, the present invention comprises a first inflatable bag; placed on the bed plate and having in an inflated state a triangular shape, with a inner and outer edges having different heights; a second inflatable bag; placed on the first inflatable bag and having in an inflated state a triangular shape, with a inner and outer edges having different heights; and a compressor for inflating and deflating the first and second inflatable bags.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a front view of the transferring device of the present invention in conjunction with a bed.

FIGS. 2a-2d are schematic illustrations of the movement of the present invention.

FIG. 3 is a schematic illustration of the movement of the present invention when transferring a patient between the bed and a stretcher.

FIG. 4 is a perspective view of the first inflatable bag of the present invention in the second embodiment.

FIG. 5 is a perspective view of the second inflatable bag of the present invention in the second embodiment.

### DESCRIPTION OF THE PREFERRED EMBODIMENTS

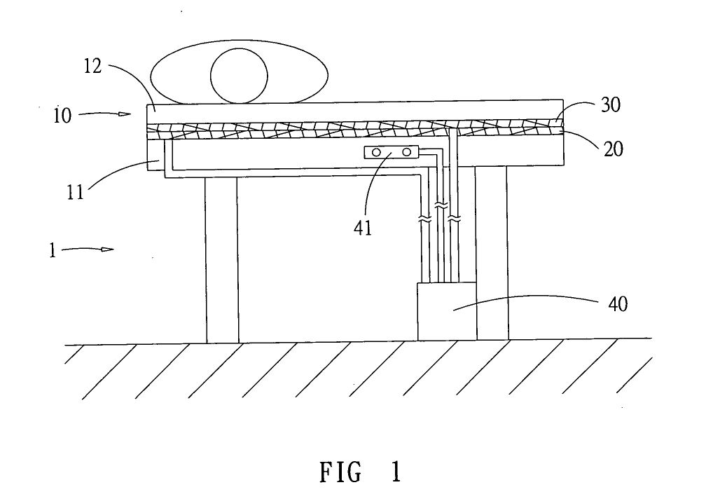

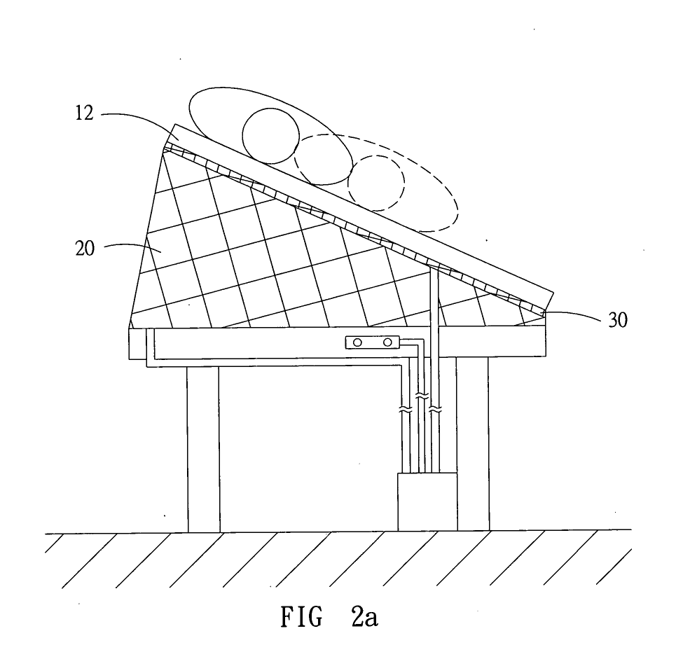

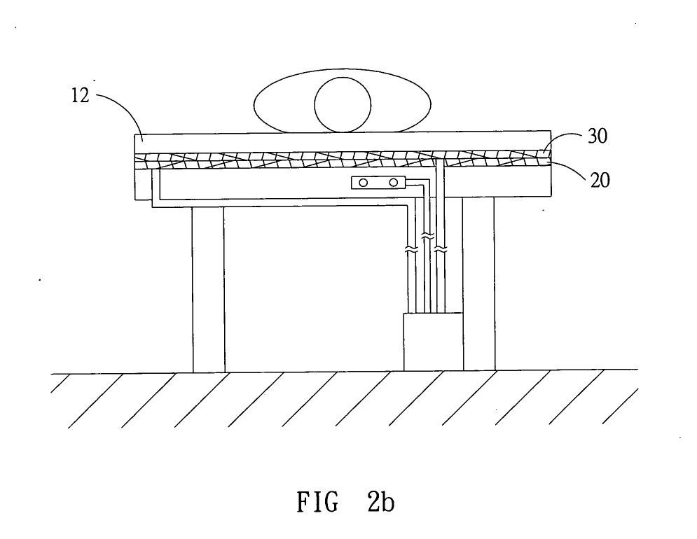

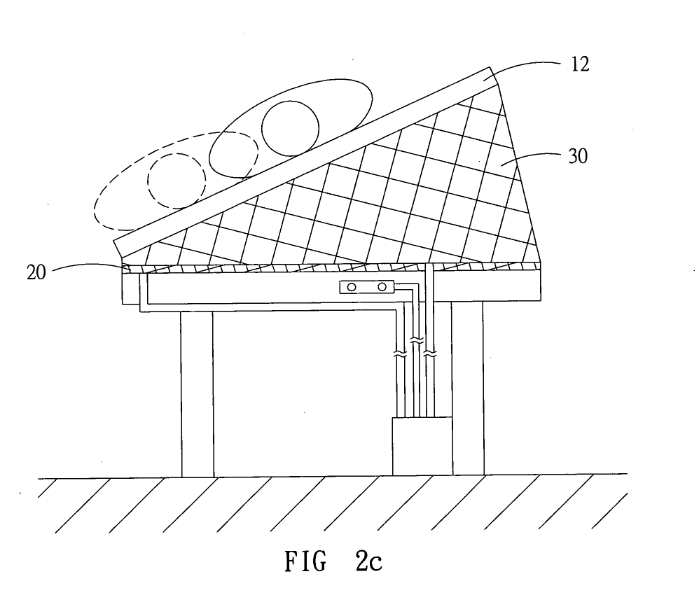

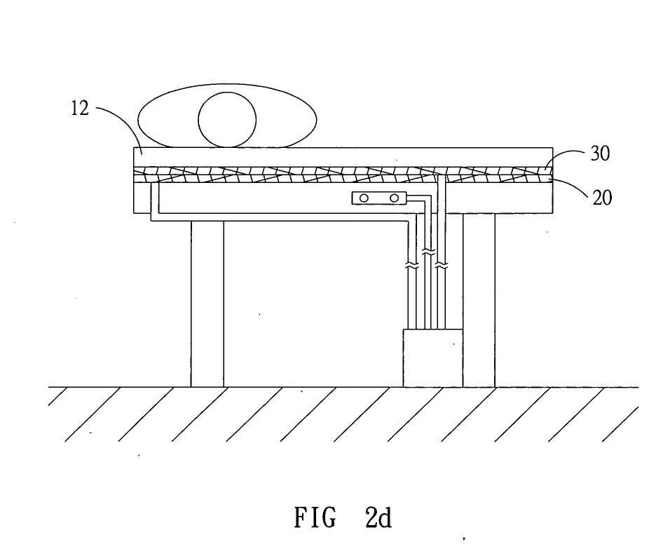

As shown in FIG. 1-2, the present invention is a transferring device 10 for a bed, used in conjunction with a bed 1 having a bed plate 11 and a mattress 12 and comprising: a first inflatable bag 20, placed on the bed plate 11; a second inflatable bag 30, placed on the bed plate 11 above the first inflatable bag 20; and a compressor 40 for inflating and deflating the first and second inflatable bags 20, 30. By inflating and deflating the first and second inflatable bags 20, 30, height differences between various areas of the bed 1 are generated, allowing conveniently to move a patient on the bed as well as into and out of the bed. In the following, a detailed description is given.

The second inflatable bag 30 is fixed on the first inflatable bag 20. In an inflated state, the first inflatable bag 20 assumes the shape of a triangle, having inner edges that reach higher than outer edges thereof. Similarly, in an, inflated state, the second inflatable bag 30 assumes the shape of a triangle, having outer edges that reach higher than inner edges thereof.

For keeping the first and second inflatable bags 20, 30 free from dirt, the mattress 12 is placed on top thereof.

The compressor 40 has a switch 41 which is operated by the patient or an assisting person for inflating and deflating the first and second inflatable bags 20, 30.

Referring to FIGS. 2a-2d, for moving the patient between an inner edge of the bed 1 and an outer edge thereof, e.g., for the purpose of replacing bandages or washing the patient, the first and second inflatable bags 20, 30 are inflated and deflated, as required. For example, to move the patient away from an inner area of the bed 1, the main first inflatable bag 21 is inflated, as shown in FIG. 2a, so that the patient is easily moved from the inner edge of the bed 1 to a central position on the bed 1. Subsequently, the first inflatable bag 20 is deflated, as shown in FIG. 2b. Similarly, to move the patient towards the inner area of the bed 1, the second inflatable bag 30 is inflated, as shown in FIG. 2c, and the patient is easily moved towards the outer edge of the bed 1. After that, the second inflatable bag 30 is deflated, as shown in FIG. 2d.

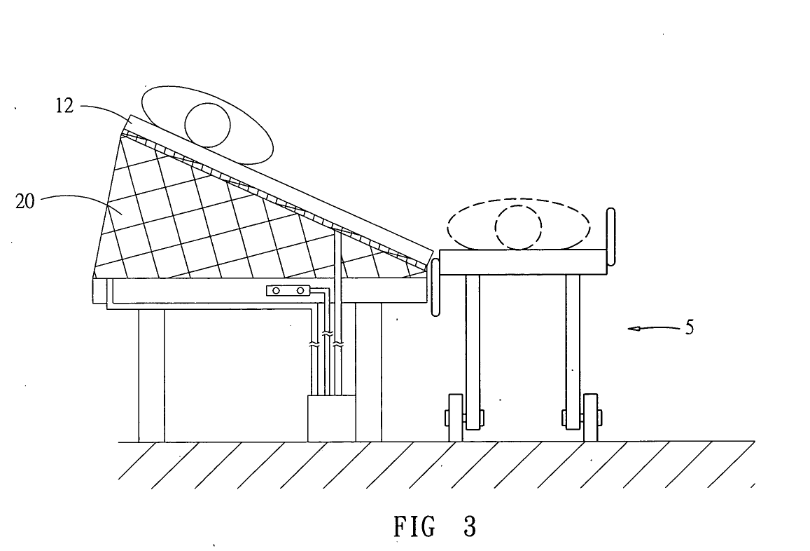

Referring to FIG. 3, for transferring the patient from the bed 1 to a stretcher 5, the stretcher 5 is first placed next to an outer edge of the bed 1, then the first inflatable bag 20 is inflated, and the patient is moved towards the outer edge of the bed 1 and on to the stretcher 5.

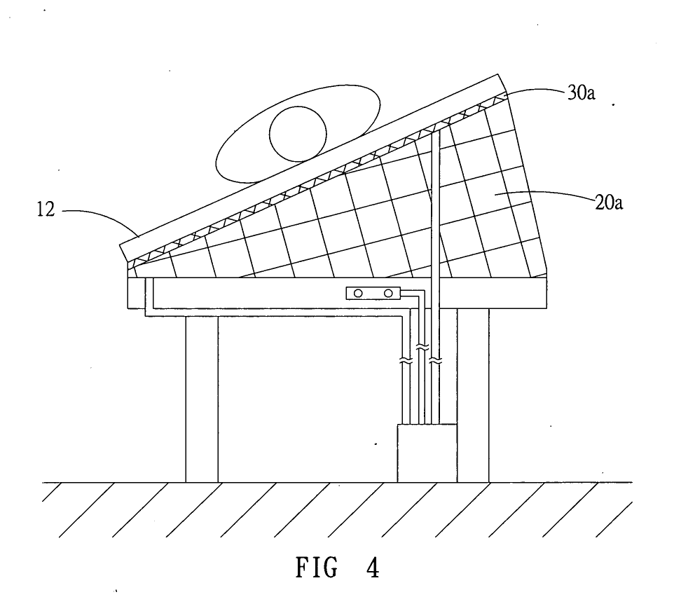

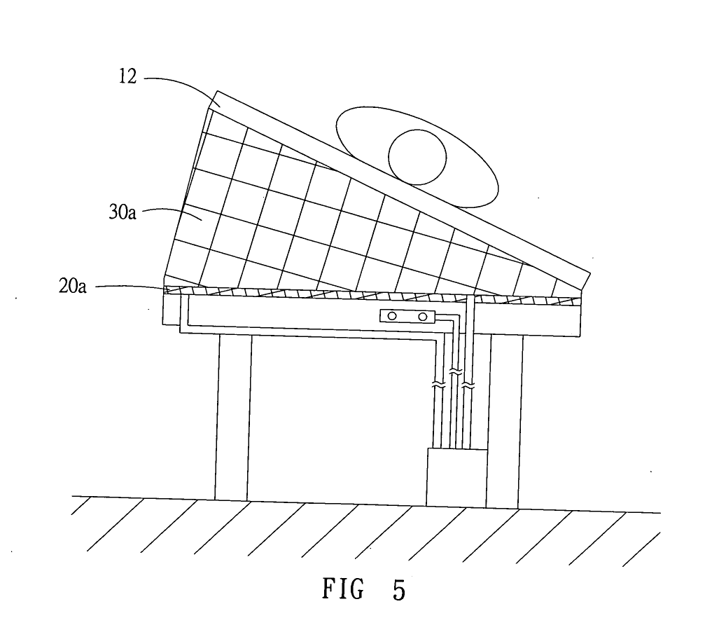

Referring to FIGS. 4 and 5, the present invention in a second embodiment has first and second inflatable bags 20a, 30a. In an inflated state, the first inflatable bag 20a assumes the shape of a triangle, having outer edges that reach higher than inner edges thereof. Similarly, in an inflated state, the second inflatable bag 30a assumes the shape of a triangle, having inner edges that reach higher than outer edges thereof.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A transferring device for a bed, placed on a bed plate, comprising:
a first inflatable bag; placed on said bed plate and having in an inflated state a triangular shape, with a inner and outer edges having different heights;
a second inflatable bag; placed on said first inflatable bag and having in an inflated state a triangular shape, with a inner and outer edges having different heights; and
a compressor for inflating and deflating said first and second inflatable bags.

2. The transferring device for a bed according to claim 1, wherein said inner edge of said first inflatable bag in said inflated state reaches higher than said outer edge thereof and said outer edge of said second inflatable bag in said inflated state reaches higher than said inner edge thereof.

3. The transferring device for a bed according to claim 1, wherein said outer edge of said first inflatable bag in said inflated state reaches higher than said inner edge thereof and said inner edge of said second inflatable bag in said inflated state reaches higher than said outer edge thereof.

4. The transferring device for a bed according to claim 1, wherein said second inflatable bag is fixed on said first inflatable bag.

5. The transferring device for a bed according to claim 1, wherein a mattress is laid on said first inflatable bag.
